(19) United States
(12) Patent Application Publication
(10) Pub. No.: US 2025/0180465 A1
(43) Pub. Date: Jun. 5, 2025

(54) TEST METHODS FOR ANTI-CORROSION COATINGS TO SIMULATE MARINE ENVIRONMENTS

(71) Applicant: CHEVRON U.S.A. INC., San Ramon, CA (US)

(72) Inventor: Aifeng YAO, San Ramon, CA (US)

(21) Appl. No.: 18/968,772

(22) Filed: Dec. 4, 2024

Related U.S. Application Data
(60) Provisional application No. 63/606,403, filed on Dec. 5, 2023.

(51) Int. Cl. G01N 17/00

(52) U.S. Cl. CPC G01N 17/00

(57) ABSTRACT

The present application relates generally to systems and methods for testing anti-corrosion coatings for suitability in marine environments. The systems and methods advantageously accurately simulate a marine environment in a laboratory such that both physical properties and antimicrobial efficacy of a coating may be tested before deployment of the coating to a mooring system.

### FIELD OF THE DISCLOSURE

The present disclosure relates to systems and methods for testing anti-corrosion coatings for suitability in marine environments.

### BACKGROUND AND SUMMARY OF THE DISCLOSURE

Mooring is a safety and integrity critical system for offshore floating facilities. Mooring line failures & preemptive replacements of long-term mooring systems often result in extensive loss of production and significant replacement cost. Many mooring failures occur at a mooring chain which is a weaker component of the mooring system due to corrosion. Such corrosion includes, but is not limited to, mega-pitting associated with microbiological influenced corrosion (MIC) due to bacteria in and around seawater.

To deal with mooring chain corrosion many different anti-corrosion coatings have been developed. Unfortunately, field performance of such coatings that have been deployed has been unsatisfactory and/or uncertain. Thus, what is needed is a pre-deployment coating test methodology. It would be beneficial if such a test methodology addressed both physical properties and antimicrobial efficacy of a coating. It would also be beneficial if the test methodology employed standard methods or combinations of standard methods that perhaps heretofore have not been employed on anti-corrosion coatings. The present application addresses these needs and more.

Aspects of the disclosed embodiments include a method for testing an anti-corrosion coating for suitability in a marine environment. The method comprises (a) conducting salt spray testing on an anti-corrosion coating according to ASTM B117 over a pre-determined period of up to about 3000 hours. The salt spray testing is interrupted at pre-determined periodic intervals during the pre-determined period. Physical properties of the anti-corrosion coating are assessed using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; ASTM D610. The steps are repeated until the completion of the pre-determined period of salt pray testing.

In another embodiment, the application pertains to a method of screening a plurality of anti-corrosion coatings for suitability in a marine environment. The method comprises testing each anti-corrosion coating in the plurality of coatings for antimicrobial efficacy using ASTM E2149-13a, ASTM D1141-98, or a combination thereof. The tested anti-corrosion coatings are selected that meet a pre-determined antimicrobial efficacy. Salt spray testing on the anti-corrosion coatings is conducted that meet a pre-determined antimicrobial efficacy according to ASTM B117 over a pre-determined period. Physical properties are assessed on the anti-corrosion coatings undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610.

In another embodiment the application pertains to a method of testing for testing an anti-corrosion coating for suitability in a marine environment. The method comprises conducting salt spray testing on an anti-corrosion coating according to ASTM B117 over a pre-determined period of up to about 2000 hours. Physical properties are periodically assessed on the anti-corrosion coating undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610. A substantial replica of the anti-corrosion coating is tested for antimicrobial efficacy using ASTM E2149-13a, ASTM D1141-98, or a combination thereof.

In additional embodiments specifications may be employed as to suitable anti-corrosion properties according to the above methods. Representative specifications are described herein.

Further features of the disclosed systems and methods, and the advantages offered thereby, are explained in greater detail hereinafter with reference to specific example embodiments illustrated in the accompanying drawings.

### DETAILED DESCRIPTION

Exemplary embodiments of the invention will now be described to illustrate various features of the invention. The embodiments described herein are not intended to be limiting as to the scope of the invention, but rather are intended to provide examples of the components, use, and operation of the invention.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

### Methods Description

The application relates generally to methods for testing an anti-corrosion coating for suitability in a marine environment and/or methods of screening a plurality of anti-corrosion coatings for suitability in a marine environment. The methods advantageously may employ determining suitability based on various combinations of physical properties, as well as antimicrobial efficacy as needed.

Many anti-corrosion coatings are designed and desired for use in a marine environment where the coating may be susceptible to salt water and/or microbes, e.g., bacteria that cause corrosion of the underlying substrate if not protected by one or more anti-corrosion coatings on an exterior of the substrate. The methods herein may facilitate in developing, employing, and/or further modifying suitable coatings for marine environments.

The specific anti-corrosion coatings that may be useful in the methods described here are not particularly limited so long as they can be tested as described. That is, the coatings may be comprised of metals, non-metals, resins, ceramics, synthetic, natural, or any combination thereof. Similarly, the form of the coating may vary so long as it is capable of undergoing one or more of the described tests. Thus, the coatings may be in the form of panels, coupons, chain links, or anything else capable of being tested via the methodology described herein.

The methods described herein typically involve conducting salt spray testing on an anti-corrosion coating according to ASTM B117 or a similar test. The conditions are generally specified in the test and may include, for example, maintaining a pH of from about 6.5 to about 7.2 during the salt spray testing and/or maintaining temperature of from about 33 to about 37° C. during the salt spray testing.

Of course, if the desired coating is known to not be susceptible to salt spray and/or if salt spray is not a concern, then this testing may not be desired. In those cases, one or more of the other testing methods or combinations thereof may be employed.

Typically, a salt spray testing on one or more anti-corrosion coatings according to ASTM B117 or a similar test is employed. While the time period for the testing may vary depending upon the desired results, the testing is often over conducted over a pre-determined period of at least about 500, or at least about 1000 hours, up to about 3000 hours, or up to about 2500 hours, or up to about 2000 hours or perhaps less depending upon the circumstances.

One or more physical properties of the one or more coatings may be assessed as desired. Such properties include, but are not limited to, properties such as adhesion, corrosion creep, blistering, rusting, cracking, flaking, impact strength, abrasion resistance, flexibility, and the like. Accordingly, one or more of the aforementioned properties may be assessed before, during, or periodically on the anti-corrosion coating that is undergoing the salt spray testing.

Such physical property tests may vary depending upon such factors as the coating and environment. In some embodiments, physical properties of the anti-corrosion coating may be assessed using one or more physical property tests selected from ASTM D4541 (pull-off adhesion), ISO 4628-2 (blistering), ISO 4628-3 (rusting), ISO 4628-4 (cracking), ISO4628-5 (flaking), ASTM D1654 (corrosion from scribe), ISO 4624 (pull off adhesion), ASTM G14 (impact strength); ASTM D4060 (abrasion resistance); NACE EP0394 (flexibility); ASTM D714 (blistering); ASTM D610 (rusting); and/or any combination thereof.

If possible and/or, if desired, the one or more physical properties may be measured before, during, and/or after the salt spray testing. In some embodiments it may be desirable to perhaps interrupt the salt spray testing at pre-determined periodic intervals during a pre-determined period. If so, then it may be desirable to perhaps repeat the steps of interrupting and measuring one or more desired physical properties until completion of a pre-determined period.

Such pre-determined periodic intervals and pre-determined periods may vary depending upon the coating, desired tests, and other factors. In some embodiments a pre-determined period may be of at least about 500, or at least about 1000 hours, up to about 3000 hours, or up to about 2500 hours, or up to about 2000 hours or perhaps less depending upon the circumstances. The pre-determined periodic intervals may vary depending upon coating, desired tests, and other factors.

In some embodiments the pre-determined periodic intervals are from about 400 to about 600 hours, e.g., about 500 hours. That is, the salt spray testing may be interrupted every 500 hours to measure one or more desired physical properties. While the salt spray test is interrupted at 500 hours, 1000 hours, 1500 hours, etc. one or more physical property tests may be conducted. These one or more physical property tests may be selected from ASTM D4541 (pull-off adhesion), ISO 4628-2 (blistering), ISO 4628-3 (rusting), ISO 4628-4 (cracking), ISO4628-5 (flaking), ASTM D1654 (corrosion from scribe), ISO 4624 (pull off adhesion), ASTM G14 (impact strength); ASTM D4060 (abrasion resistance); NACE EP0394 (flexibility); ASTM D714 (blistering); ASTM D610 (rusting); and/or any combination thereof. Once the desired tests are conducted then the salt spraying test may resume until the next periodic interval or the conclusion of the pre-determined period. In some embodiments, it may be desired to conduct one or more of the aforementioned tests at the conclusion of any salt spraying test and assess the change in one or more specific properties over the course of the testing.

If desired, other testing may be conducted before any salt spray testing, during any salt spray testing, or after any salt spray testing. Other testing may involve one or more tests for antimicrobial efficacy. The one or more antimicrobial efficacy tests are not particularly limited and may include, for example, ASTM E2149-13a and/or ASTM D1141-98.

### EXAMPLES

### Example 1

A potential coating is evaluated prior to salt spray testing to ensure it substantially meets the following performance criteria:

### Proposed Performance Requirements-Before Exposure to Salt Spray

Adhesion resistance: ISO 4624, Minimum pull-off value of 8.0 MPa for 1 coat schemes or 5.0 MPa for 2 coat schemes
Abrasion resistance: ASTMD4060, Maximum 100 mg per 1000 revolutions.
Impact resistance: ASTMG14, Minimum requirement 100 lb.f. in. (11.3 N·m) with no crack or disbond.
Flexibility: NACE SP0394, Coated panels shall bend over 2.0 degree and 2.5-degree with no failure, cracking, or disbonding.

Coatings that substantially meet the performance requirements above may then be subjected to salt spray testing. Salt spray testing is conducted on a flat sample comprising an anticorrosion coating for 2000 hours. The salt spray testing is interrupted at 500 hours, 1000 hours, 1500 hours, and 2000 hours to conduct one or more of the following tests: ASTM D4541 (pull-off adhesion), ISO 4628-2 (blistering), ISO 4628-3 (rusting), ISO 4628-4 (cracking), ISO4628-5 (flaking), ASTM D1654 (corrosion from scribe), ISO 4624 (pull off adhesion), ASTM G14 (impact strength); ASTM D4060 (abrasion resistance); NACE EP0394 (flexibility); ASTM D714 (blistering); and ASTM D610 (rusting).

After exposure to the salt spray testing for 200 hours, then one or more tests such as the above are conducted. In some embodiments desired coatings are those that meet the below performance requirements.

### Proposed Performance Requirements-after Exposure to Salt Spray

Defect assessment: ASTM4628-2, -3, and -4. No blistering, no rusting, no cracking (assessed immediately).

Adhesion: ASTM B117 and ISO 4624, Minimum pull-of=75% of original value after 2000 hours continuous exposure to salt spray.

Corrosion from a scribe line: ASTMB1117, A maximum of ≤1.5 mm as average value for high impact areas (e.g., floors, lay-down area, helideck, escape routes, splash zone).

### Example 2

The coatings tested in Example 1 may additionally have tests conducted to evaluate the antimicrobial efficacy over time in laboratory conditions. These tests may be conducted prior to or after any salt spraying and other tests. In some embodiments, the antimicrobial efficacy tests may be conducted before or immediately after the tests for determining whether a coating meets the Proposed Performance Requirements-before exposure to salt spray. In this manner, coatings that fail any of these preliminary tests may be eliminated as desired and not subjected to the 2000 hour salt spraying testing.

### Representative Test Organisms, Agents, Methodology, and Predicted Outcomes

Organism 1: Deltaproteobacteria; Organism 2: Alphaproteabacteria
Cell Types: Desulfovibriovulgaris and Roseovariuscrassostreae
Agents: Each of 4 coatings, 5 single-link chain samples per coating (4 coated plus one uncoated)
Methodology: mimic ASTM E2149-13a
Test 1: organism 1, 2 batch test, 5 samples per batch.
Test 2: organism 2, 2 batch test, 5 samples per batch.
Predicted Outcomes: Quantitative analysis of the viability of Organisms 1 and 2 on each of the 4 coatings-calculating percentage or log bacterial reduction.
Representative protocols are described below.

### Representative Protocol 1

1) Prepared and labeled sterile tubes for 10-fold dilutions with 2.7 ml of artificial seawater (ASW) (“Artificial Seawater” ASTM D1141-98) in 20% glycerol to approximately 10-3 for T=0 and each sampling interval for 4 hours (stored overnight at 4 C). a. Prepared and labeled Marine Broth 2216 agar plates for each dilution factor, sample, and hour interval. Agar plates were left out overnight to reach room temperature. b. Sterilized 1 liter of ASW, five containers, five chain links, and ASW 20% glycerol in an autoclave (day before the experiment).
2) Diluted 0.5 ml of standardized culture in 4.5 ml of sterile ASW 20% glycerol to achieve 108 cells/ml. a. Inoculated 1 ml of standardized bacterial culture dilution in 1 liter of sterile ASW to achieve 105 cells/ml.
3) Mixed solution to suspend cells evenly and removed 0.3 ml sample (T=0) for each chain link container (starting cell concentration of 101 for T=0). a. Poured 200 ml of standardized bacterial inoculum into each chain link container.
4) Incubated chain-link containers with shaking (200 rpm at 26° C.).
5) Aseptically removed sample from each container and placed into sterile dilution tube. Samples were withdrawn every hour for a period of 4 hours.
6) Diluted each sample in ASW 20% glycerol to 103 dilution factor, vortexed dilution tube between each dilution.
7) Dilute was plated using Eddy Jet 2W Spiral Plater using linear mode, 0.1 mL, three plates per dilution. a. Plated all dilutions 101 to 103.
8) Allowed plates to dry, then incubated for 48 hours at 26° C.
9) After incubation, colonies were counted with Sphere Flash Automated Colony Counter. Plate counts were recorded, and plates were disposed of in biohazard waste.

### Representative Protocol 2

1) Prepared and labeled BAAR's media with Oxyrase™ for agar agar plates with sample name, time interval, and dilution factor. a. Agar plates were left out overnight to reach room temperature. b. Agar plates were placed in BD Gaspak jars to avoid O2 exposure.
2) Prepared and labeled sterile tubes for 10-fold dilutions with 4.5 ml of sterile artificial seawater (ASW) to approximately 10-2 for T=0 and each sampling interval for 4 hours. a. Samples (0.5 ml) were taken at 1-hour intervals.
3) Autoclaved 2.5 L of ASW in 5 anaerobic link containers.
4) Aseptically placed sterile chain-link in anaerobic link container with ASW then sealed the container.
5) Sparged O2 in the headspace of the anaerobic link container with N2 using a cannula gassing system (FIG. 10). a. Sparge length was 25-30 minutes. b. Thermofluid equation was used to determine the sparge time (attached).
6) Inoculated sterile ASW in a modified container with 10 ml of BAAR's broth with D. vulgaris (ATCC 29579). a. 10 cc syringe barrel with 21G 2-inch needles were used for inoculation. b. Drew sterile ASW first, then broth to reduce the exposure to O2. c. Inoculated 50 ml of sterile ASW with 1 ml of BAAR's broth with D. vulgaris for T=0 sample.
7) Place modified containers in a shaker incubator (FIG. 11) at 300 C and 80 RPM.
8) Samples (0.5 ml) were taken every hour for 4 hours with a 21G 2-inch needle with a 3 cc syringe barrel. a. Samples taken were diluted in a 10-fold series up to 100× b. Gently mixed after adding sample to each dilution to reduce O2 exposure c. Each sample diluted in sterile ASW.
9) Sample dilutions were plated using Eddy Jet 2W Spiral Plater using linear mode, 0.1 mL, three plates per dilution. a. Sample dilutions were plated on BAAR's media with Oxyrase™ for agar. b. Inoculated plates were placed in BD gaspak jar to reduce O2 exposure while they dry & to keep Oxyrase™ enzyme active as long as possible.
10) Placed inoculated plates in an incubator for 48 hours at 30° C.
11) After incubation, colonies were counted with Sphere Flash Automated Colony Counter. a. Colony counts were recorded and converted to Viable counts per milliliter (Vc/ml) b. Plates were disposed of in Biohazard waste bin.

The coatings that meet the desired antimicrobial efficacy may then be further tested for physical properties and/or subjected to saltwater testing as described above.

### Specific Embodiments

1. A method for testing an anti-corrosion coating for suitability in a marine environment, wherein the method comprises:
   (a) conducting salt spray testing on an anti-corrosion coating according to ASTM B117 over a pre-determined period of up to about 3000 hours; and
   (b) interrupting the salt spray testing at pre-determined periodic intervals during the pre-determined period; and
   (c) assessing physical properties of the anti-corrosion coating using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; ASTM D610; and
   (d) repeating steps (a) to (c) until the completion of the pre-determined period.
2. The method of any preceding embodiment which further comprises conducting one or more tests on the anti-corrosion coating prior to the conducting of salt spray testing.
3. The method of any preceding embodiment wherein the one or more prior tests comprise a test for antimicrobial efficacy.
4. The method of any preceding embodiment wherein the one or more prior tests comprise a test selected from the group consisting of ISO 4624, ASTM D4060; ASTM G14, NACE SP0394, or any combination thereof.
5. The method of claim 1 which further comprises conducting one or more tests on the anti-corrosion coating after the pre-determined period of conducting of salt spray testing.
6. The method of any preceding embodiment wherein the one or more tests conducted after the pre-determined period comprise a test selected from the group consisting of ISO 4628-2, ISO-4628-3, ISO 4628-4, ISO 4624, or any combination thereof.
7. The method of any preceding embodiment wherein the pre-determined periodic intervals are from about 400 to about 600 hours.
8. The method of any preceding embodiment wherein the pre-determined periodic intervals are about 500 hours.
9. The method of any preceding embodiment wherein the pH is from about 6.5 to about 7.2 during the salt spray testing.
10. The method of any preceding embodiment wherein the temperature is from about 33 to about 37° C. during the salt spray testing.
11. A method of screening a plurality of anti-corrosion coatings for suitability in a marine environment, wherein the method comprises:
   (a) testing each anti-corrosion coating in the plurality of coatings for antimicrobial efficacy using ASTM E2149-13a, ASTM D1141-98, or a combination thereof;
   (b) selecting the tested anti-corrosion coatings that meet a pre-determined antimicrobial efficacy; and
   (c) conducting salt spray testing on the anti-corrosion coatings that meet a pre-determined antimicrobial efficacy according to ASTM B117 over a pre-determined period; and
   (d) assessing physical properties on the anti-corrosion coatings undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610.
12. The method of any preceding embodiment which further comprises conducting one or more tests on the plurality of anti-corrosion coatings prior to the conducting of salt spray testing and wherein the one or more prior tests comprise a test selected from the group consisting of ISO 4624, ASTM D4060; ASTM G14, NACE SP0394, or any combination thereof.
13. The method of any preceding embodiment which further comprises conducting one or more tests on the on the plurality of anti-corrosion coatings after the salt spray testing wherein the one or more tests conducted after the salt spray testing comprise a test selected from the group consisting of ISO 4628-2, ISO-4628-3, ISO 4628-4, ISO 4624, or any combination thereof.
14. The method of any preceding embodiment wherein the pH is from about 6.5 to about 7.2 during the salt spray testing and wherein the temperature is from about 33 to about 37° C. during the salt spray testing.
15. A method of testing for testing an anti-corrosion coating for suitability in a marine environment, wherein the method comprises:
   (a) conducting salt spray testing on an anti-corrosion coating according to ASTM B117 over a pre-determined period of up to about 2000 hours; and
   (b) periodically assessing physical properties on the anti-corrosion coating undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610; and
   (c) testing a substantial replica of the anti-corrosion coating for antimicrobial efficacy using ASTM E2149-13a, ASTM D1141-98, or a combination thereof.
16. The method of any preceding embodiment which further comprises conducting one or more tests on the anti-corrosion coating prior to the conducting of salt spray testing wherein the one or more prior tests comprise a test for antimicrobial efficacy.
17. The method of any preceding embodiment which further comprises conducting one or more tests on the anti-corrosion coating prior to the conducting of salt spray testing wherein the one or more prior tests comprise a test selected from the group consisting of ISO 4624, ASTM D4060; ASTM G14, NACE SP0394, or any combination thereof.
18. The method of any preceding embodiment which further comprises conducting one or more tests on the anti-corrosion coating after the salt spray testing wherein the one or more tests comprise a test selected from the group consisting of ISO 4628-2, ISO-4628-3, ISO 4628-4, ISO 4624, or any combination thereof.
19. The method of any preceding embodiment wherein the pH is from about 6.5 to about 7.2 during the salt spray testing.
20. The method of any preceding embodiment wherein the temperature is from about 33 to about 37° C. during the salt spray testing.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A method for testing an anti-corrosion coating for suitability in a marine environment, wherein the method comprises:
(a) conducting salt spray testing on an anti-corrosion coating according to ASTM B117 over a pre-determined period of up to about 3000 hours; and
(b) interrupting the salt spray testing at pre-determined periodic intervals during the pre-determined period; and
(c) assessing physical properties of the anti-corrosion coating using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; ASTM D610; and
(d) repeating steps (a) to (c) until the completion of the pre-determined period.

2. The method of claim 1 which further comprises conducting one or more tests on the anti-corrosion coating prior to the conducting of salt spray testing.

3. The method of claim 2 wherein the one or more prior tests comprise a test for antimicrobial efficacy.

4. The method of claim 2 wherein the one or more prior tests comprise a test selected from the group consisting of ISO 4624, ASTM D4060; ASTM G14, NACE SP0394, or any combination thereof.

5. The method of claim 1 which further comprises conducting one or more tests on the anti-corrosion coating after the pre-determined period of conducting of salt spray testing.

6. The method of claim 5 wherein the one or more tests conducted after the pre-determined period comprise a test selected from the group consisting of ISO 4628-2, ISO-4628-3, ISO 4628-4, ISO 4624, or any combination thereof.

7. The method of claim 1 wherein the pre-determined periodic intervals are from about 400 to about 600 hours.

8. The method of claim 1 wherein the pre-determined periodic intervals are about 500 hours.

9. The method of claim 1 wherein the pH is from about 6.5 to about 7.2 during the salt spray testing.

10. The method of claim 1 wherein the temperature is from about 33 to about 37° C. during the salt spray testing.

11. A method of screening a plurality of anti-corrosion coatings for suitability in a marine environment, wherein the method comprises:
(a) testing each anti-corrosion coating in the plurality of coatings for antimicrobial efficacy using ASTM E2149-13a, ASTM D1141-98, or a combination thereof;
(b) selecting the tested anti-corrosion coatings that meet a pre-determined antimicrobial efficacy; and
(c) conducting salt spray testing on the anti-corrosion coatings that meet a pre-determined antimicrobial efficacy according to ASTM B117 over a pre-determined period; and
(d) assessing physical properties on the anti-corrosion coatings undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610.

12. The method of claim 11 which further comprises conducting one or more tests on the plurality of anti-corrosion coatings prior to the conducting of salt spray testing and wherein the one or more prior tests comprise a test selected from the group consisting of ISO 4624, ASTM D4060; ASTM G14, NACE SP0394, or any combination thereof.

13. The method of claim 11 which further comprises conducting one or more tests on the on the plurality of anti-corrosion coatings after the salt spray testing wherein the one or more tests conducted after the salt spray testing comprise a test selected from the group consisting of ISO 4628-2, ISO-4628-3, ISO 4628-4, ISO 4624, or any combination thereof.

14. The method of claim 11 wherein the pH is from about 6.5 to about 7.2 during the salt spray testing and wherein the temperature is from about 33 to about 37° C. during the salt spray testing.

15. A method of testing for testing an anti-corrosion coating for suitability in a marine environment, wherein the method comprises:
(a) conducting salt spray testing on an anti-corrosion coating according to ASTM B117 over a pre-determined period of up to about 2000 hours; and
(b) periodically assessing physical properties on the anti-corrosion coating undergoing the salt spray testing using one or more physical property tests selected from ASTM D4541, ISO 4628-2, ISO 4628-3, ISO 4628-4, ISO4628-5, ASTM D1654, ISO 4624, ASTM G14; ASTM D4060; NACE EP0394; ASTM D714; and ASTM D610; and
(c) testing a substantial replica of the anti-corrosion coating for antimicrobial efficacy using ASTM E2149-13a, ASTM D1141-98, or a combination thereof.

16. The method of claim 15 which further comprises conducting one or more tests on the anti-corrosion coating prior to the conducting of salt spray testing wherein the one or more prior tests comprise a test for antimicrobial efficacy.

17. The method of claim 15 which further comprises conducting one or more tests on the anti-corrosion coating prior to the conducting of salt spray testing wherein the one or more prior tests comprise a test selected from the group consisting of ISO 4624, ASTM D4060; ASTM G14, NACE SP0394, or any combination thereof.

18. The method of claim 15 which further comprises conducting one or more tests on the anti-corrosion coating after the salt spray testing wherein the one or more tests comprise a test selected from the group consisting of ISO 4628-2, ISO-4628-3, ISO 4628-4, ISO 4624, or any combination thereof.

19. The method of claim 15 wherein the pH is from about 6.5 to about 7.2 during the salt spray testing.

20. The method of claim 15 wherein the temperature is from about 33 to about 37° C. during the salt spray testing.
